(19) United States
(12) Patent Application Publication
(10) Pub. No.: US 2017/0165817 A1
(43) Pub. Date: Jun. 15, 2017

(54) Impact Wrench and Method for Operating an Impact Wrench

(71) Applicant: C. & E. Fein GmbH, Schwaebisch Gmuend (DE)

(72) Inventors: Adrian Vogt, Oechsen (DE); Anatoli Pankraz, Schwaebisch Gmuend (DE)

(21) Appl. No.: 15/323,931

(22) PCT Filed: Apr. 27, 2015
(86) PCT No.: PCT/EP2015/059098

§ 371 Date: Jan. 4, 2017

(30) Foreign Application Priority Data
Jul. 4, 2014 (DE) 10 2014 109 412.3

(51) Int. Cl. B25B 21/02

(52) U.S. Cl. CPC B25B 21/026

(57) ABSTRACT

An impact wrench and a method for operating an impact wrench are disclosed. In an embodiment, an impact wrench includes a housing, a motor-driven input shaft, an output shaft for mounting a tool and a hammer mechanism for transmitting a torque and coupling the input shaft to the output shaft, wherein a first bearing torque, which acts against a rotational direction of the output shaft, is present between the output shaft and the housing, wherein a second bearing torque, which acts against a rotational direction of the input shaft, is present between the output shaft and the input shaft when the input shaft is not coupled to the output shaft by the hammer mechanism, and wherein an absolute value of the first bearing torque is smaller than an absolute value of the second bearing torque.

### CROSS-REFERENCE TO RELATED APPLICATIONS

This patent application is a national phase filing under section 371 of PCT/EP2015/059098, filed Apr. 27, 2015, which claims the priority of German patent application 10 2014 109 412.3, filed Jul. 4, 2014, each of which is incorporated herein by reference in its entirety.

### TECHNICAL FIELD

The present invention relates to an impact wrench, in particular a tangential impact wrench, and further to a method for loosening and/or fastening a screw joint by a tangential impact wrench.

### BACKGROUND

From EP 1 510 394 B1 an impact wrench is known, which provides periodically and temporarily a large tightening torque for tightening screws or for setting of screw anchors.

Generally tangential impact wrenches are suitable for setting screws in a variety of materials with different hardness, such as aerated concrete, sand-lime brick, brick, stone or concrete. For this purpose a hammer mechanism is used, in which two impactors, hammer and anvil, are mutually accelerated and transmit pulse-like kinetic energy upon contact.

### SUMMARY

Embodiments of the invention provide an impact wrench having a lower wear of the hammer mechanism. Further embodiments of the invention provide a method for operating an impact wrench by which a threshold value is achievable more accurately and faster.

Various embodiments include an impact wrench having a housing, a motor-driven input shaft, an output shaft for mounting a tool, and a hammer mechanism coupling the input shaft to the output shaft for transmitting a torque, wherein a first bearing torque is present between the output shaft and the housing, which acts against the rotational direction of the output shaft, wherein a second bearing torque, which acts against the rotational direction of the input shaft, is present between the output shaft and the input shaft particularly when not coupling the input shaft to the output shaft by means of the hammer mechanism, characterized in that the first bearing torque is smaller than the second bearing torque.

Various other embodiments provide a method for loosening or fastening a screw joint by means of a tangential impact wrench having the steps of: carrying out impact cycles, wherein within an impact cycle a rotor of a hammer mechanism is alternatingly in engagement in a first time interval and not in engagement in a second time interval with an anvil and providing a torque to the screw joint particularly during the second time interval, said torque being in the range of 10 mNm to 500 mNm, preferably in the range of 50 mNm to 400 mNm, more preferably in the range of 250 mNm to 350 mNm.

Various further embodiments provide method for operating a tangential impact wrench having the steps: attaching a plug-on tool to an output shaft of a tangential impact wrench; establishing an engagement of the plug-on tool with a means of fastening corresponding to the plug-on tool; carrying out impact cycles wherein within an impact cycle a rotor of a hammer mechanism is alternatingly in engagement in a first time interval and not in engagement in a second time interval with an anvil of a hammer mechanism and providing a damping means for reducing a play against the rotational direction of the output shaft between the means of fastening, the plug-on tool and the output shaft.

By means of a friction bearing between the output shaft and/or the anvil and the input shaft, the output shaft may also be driven between the individual tangential impacts in rotational direction with a low torque. A reverse rotation of the output shaft is prevented, and thus it is ensured that the respective next impact is induced into the screw as completely as possible.

By means of the inventive torque transmission between the input shaft and the output shaft and/or an anvil of the output shaft having a higher bearing torque or higher bearing torques, higher torques by individual impacts and smaller torque variations from impact to impact can be achieved. It is therefore advantageous to provide a more effective impact utilization as well as less time needed to reach a certain fastening torque or loosen a screw joint, in particular a screw. This results in a reduced wear of the hammer mechanism by means of said shortened screwing times.

It has been found that the torque transmitted during the impact depends greatly on the angular position between the anvil, the tool, typically a socket, and the screw joint or screw anchor. In particular, the impact force, which ultimately acts on a screw, i.e. the kinetic energy transmitted during the impact of the hammer on the anvil and further via a socket to the screw, depends greatly on the rigidity and the rotational play of the connection of the three latter components. The less rotational play between the screw, socket and output shaft and/or the anvil formed thereon is present, the higher the peak torques that can be transmitted.

The bearing torque is defined herein as the sum of all torques, which are present between the elements referred to in this context in the claims. Common to these torques is that they are directed opposite to the respective direction of rotation of the motor drive of the impact wrench, which is considered in the prior art as generally undesirable, however, the invention recognizes and exploits as beneficial. In particular, it is stated that the bearing torque is not restricted to the torques that rolling-elements bearings have, but all torques, which are caused for example by sliding friction, rolling friction or even a frictional connection, as can be done by a slip clutch, shall be included. As is known, bearing torques have in common that they vary depending on parameters such as speed, temperature, surface roughness of the bearing roller, etc. In sufficient approximation and without limitation, for example, a bearing torque, averaged over a period of one second, at room temperature of 20 degrees Celsius and a rotational speed of the drive spindle of 2000 rev/min, can be considered a bearing torque in the sense of the present invention.

It has been found to be particularly advantageous for an effective impact utilization if the first bearing torque is in the range of 5 mNm to 200 mNm, preferably in the range of 10 mNm to 100 mNm, more preferably in the range of 20 mNm to 70 mNm. Furthermore, has proved favorable for an effective impact utilization, that the second bearing torque is greater by least a factor of 1.1, particularly by at least a factor of 2, preferably by at least a factor of 5 than the first bearing torque.

In general, an improvement of the impact utilization is to be expected when the second bearing torque is greater by at least 10 mNm, better at least 50 mNm, preferably by at least 100 mNm, more preferably by at least 200 mNm than the first bearing torque.

The impact wrench can be further developed in an embodiment in that the first bearing torque is formed by at least one bearing, in particular a rolling-element bearing, wherein the rolling-element bearing is arranged between the output shaft and the housing of the impact wrench. Further bearings, in particular also further rolling-element bearings, may also be arranged between the output shaft and the housing and also provide a contribution with their respective torques to the first bearing torque.

At this point it is noted that the bearing torques do not form a constant but usually vary depending on e.g. on the temperature, the rotational speed and also on wear. Although the variance may be relatively small and may be only a few 10 mNm, therefor the bearing torque must in each case be specified with a range or otherwise be understood as an average value.

With the higher second bearing torque an improved impact utilization results in accordance with the invention. The motor of the tangential impact wrench will however be stressed correspondingly with a higher second bearing torque, whereby an upper limit for the second bearing torque results, which should not be exceeded for reasons of economy.

In one embodiment is provided that the second bearing torque is formed by at least one O-ring. The O-ring is inserted preferably tensioned in one of the shafts or in both for attaining the relatively higher second bearing torque. The advantage of using an O-ring for attaining the second bearing torque is the low manufacturing cost of this component.

In a further embodiment the second bearing torque may be formed by at least one friction bearing or a preloadable rolling-element bearing, in particular a needle roller bearing or a ball bearing. In particular, the rolling-element bearing may in this case be formed as a per se known friction bearing, which produces a frictional torque e.g. via crossed rolling-elements. The preload can be applied for example by a spring washer.

In a further embodiment the second bearing torque may be applied by at least one slip clutch.

Further, the second bearing torque may be formed in another embodiment by a bushing connection between the input shaft and the output shaft. Via a fit or press-fit the bushing connection forms a sliding torque, which may correspond to the bearing torque, and/or supply a portion of the bearing torque.

An embodiment of the impact wrench may further be that the first and/or the second bearing torque is formed by a plurality of bearing elements.

### BRIEF DESCRIPTION OF THE DRAWINGS

In the following the invention will be explained in more detail with reference to embodiments.

FIG. 1 shows a sectional view of the front part of an impact wrench;

FIG. 2 shows the impact wrench according to FIG. 1 in a sectional view;

FIG. 3 shows a diagram of a torque measurement of an impact wrench according to the prior art; and

FIG. 4 shows a diagram of a torque measurement of an impact wrench according to FIGS. 1 and 2.

### DETAILED DESCRIPTION OF ILLUSTRATIVE EMBODIMENTS

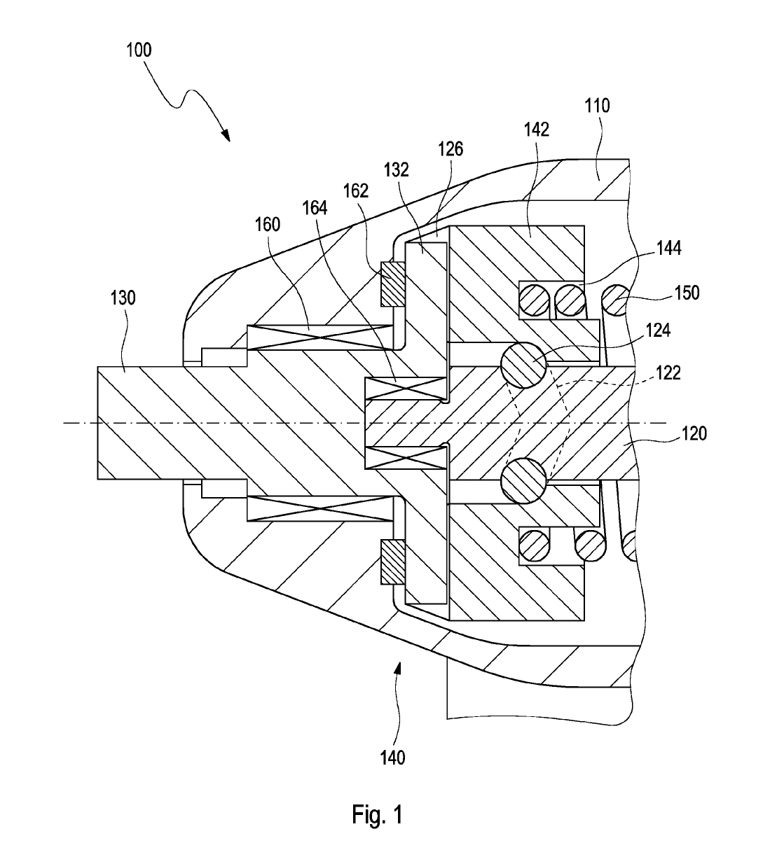

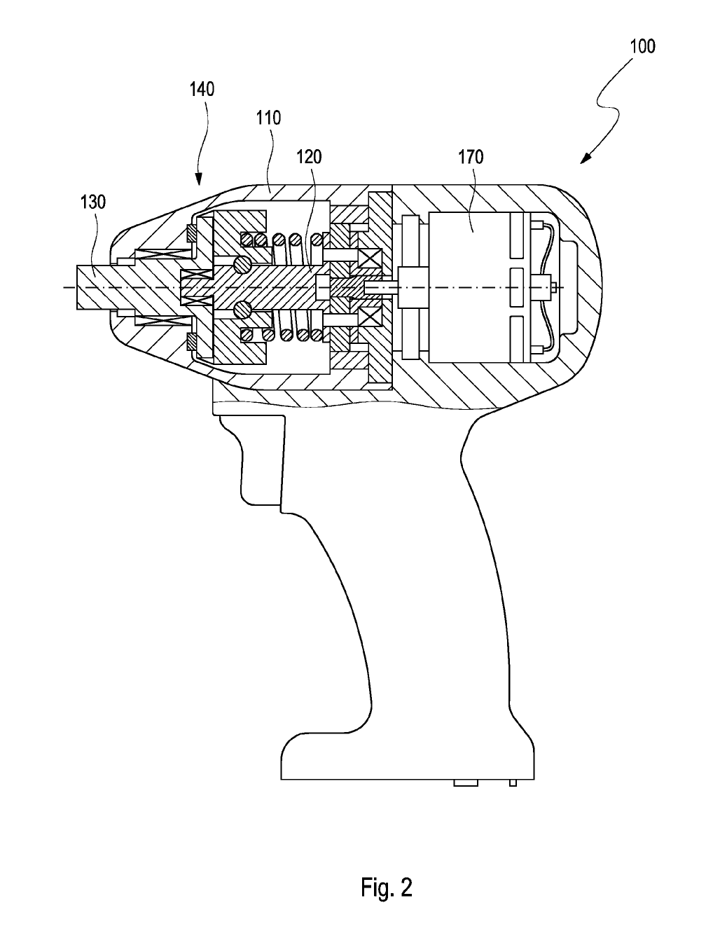

FIG. 1 shows an tangential impact wrench 100 in a sectional view of its front part and FIG. 2 shows complete tangential impact wrench 100 with motor 170.

In a housing 110 of the tangential impact wrench 100 an electric motor-driven input shaft 120 and also an output shaft 130 which can be coupled to said input shaft by means of a hammer mechanism 140 is arranged. On the input shaft 120 are two cams 122 running helically around each other and indicated by dashed lines, in each of which a ball 124 runs. The two balls 124 are contacting a rotor 142. Further, on the rotor 142 a hammer 126 is formed. The hammer 126 in this case is contacting an anvil 132 integrally connected with the output shaft 130 at the end. Further, a return spring 150 engages in a recess 144 of the rotor 142. A first bearing torque is formed by a bearing torque of a rolling-element bearing 160 which is formed between the housing 110 and the output shaft 130 and another bearing torque of a teflon disk 162, which is formed between the housing 110 and the anvil 132 of the output shaft 130. A second bearing torque is formed by a friction bearing 164. For said first bearing torque an average value of about 0.03 Nm or 30 mNm at a rotational speed during idle operation of a tangential impact wrench according to the invention was detected by measurement. The difference between the detected maximum and minimum values of the bearing torques was about 90 mNm.

If sufficient torque is applied from the background, the hammer mechanism 140 of the tangential impact wrench 100 will impact. Starting from the initial position shown the rotor 142 is in engagement with the anvil 132 by means of the hammer 126 and thus with the output shaft 130. The rotor 142 is prevented by the anvil 132 from co-rotating in the rotational direction of the input shaft 120. Instead, the cam 122 forces the rotor 142 to move in the direction of the rotational axis out of engagement with the anvil 132. Out of engagement with the anvil, the rotor 142 can co-rotate with the input shaft 120 and relative to the anvil 132. In the course of this the anvil 132 and the hammer 126 come back again in a position in which they engage. The return spring 150 drives the rotor 142 back to the anvil 132. The rotor is thereby accelerated in direction of the longitudinal axis and receives from the forced operation of the cam 122 a rotary motion with a corresponding angular momentum. The rotary motion of the rotor 142 is stopped by the lateral stop of the hammers 126 of the rotor 142 on the anvil 132 and the angular momentum is transferred almost completely to the anvil 132 and the tool, not shown here, in the form of a socket and to the screw connection, also not shown. The system is in the starting position again and another impact cycle begins.

The first bearing torque, which is present between the output shaft 130 and the housing 110, acts against the rotational direction of the output shaft 130 and a second bearing torque, particularly also when not coupling the input shaft 120 to the output shaft 130 by means of the hammer mechanism 140, is present between the output shaft 130 and the input shaft 120 and also acts against the rotational direction of the input shaft 120. The second average bearing torque may be, for example, about 50 mNm larger than the first average bearing torque. Thereby, the output shaft 130 is still driven via the friction bearing 164, which forms the second bearing torque, with a low drive torque by the input shaft 120 between the above-described exemplary tangential impact cycles. A a result a reverse rotation of the output shaft 130 is prevented and the next impact is introduced into the screw or other fasteners as completely as possible.

In FIG. 3 the torque of a tangential impact wrench known from the prior art is plotted against time. The scaling is 20 Nm for the torque and 0.5 seconds for the time.

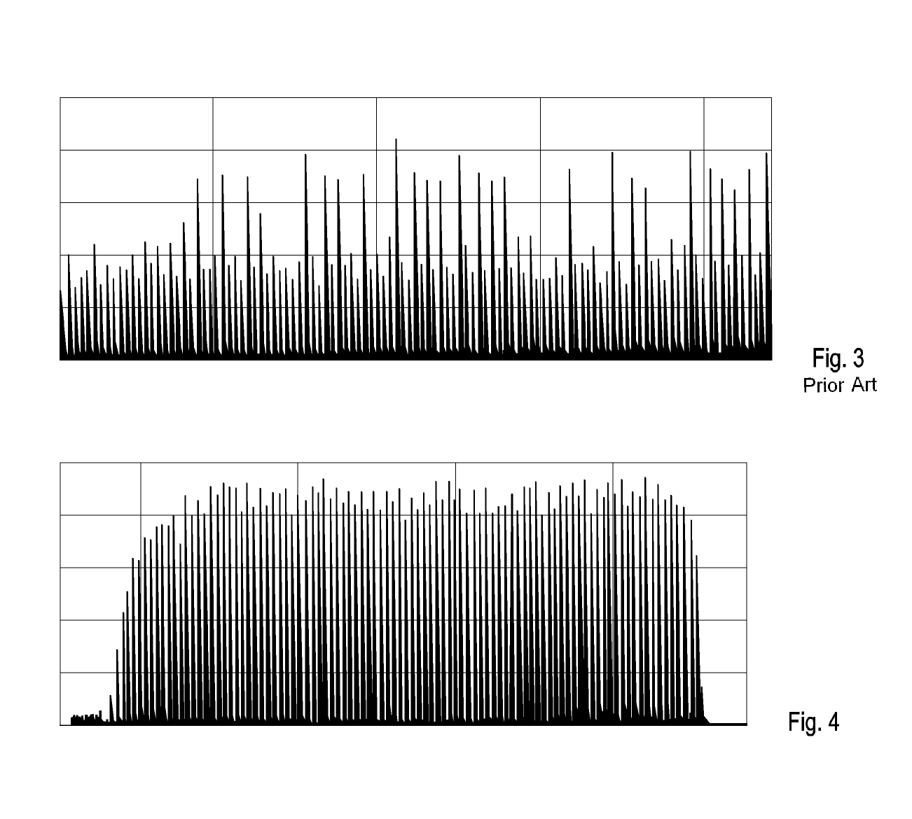

In FIG. 4, with identical scaling, the torque of this tangential impact wrench 100 is plotted against time, wherein a common bearing was replaced by a friction bearing 164. Noticeably the torque in FIG. 4 is smoother and at a much higher level with a plateau of peak amplitudes at more than 150 Nm.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

### LIST OF REFERENCE NUMBERS

100 tangential impact wrench
110 housing
120 input shaft
122 cam
124 ball
126 hammer
130 output shaft
132 anvil
140 hammer mechanism
142 rotor
144 recess
150 return spring
160 rolling-element bearing
162 teflon disk
164 friction bearing
170 motor

1-9. (canceled)

10. An impact wrench comprising:
a housing;
a motor-driven input shaft;
an output shaft for mounting a tool; and
a hammer mechanism for transmitting a torque and coupling the input shaft to the output shaft,
wherein a first bearing torque, which acts against a rotational direction of the output shaft, is present between the output shaft and the housing,
wherein a second bearing torque, which acts against a rotational direction of the input shaft, is present between the output shaft and the input shaft when the input shaft is not coupled to the output shaft by the hammer mechanism, and
wherein an absolute value of the first bearing torque is smaller than an absolute value of the second bearing torque.

11. The impact wrench according to claim 10, wherein the first bearing torque is in a range of 5 mNm to 200 mNm.

12. The impact wrench according to claim 10, wherein the second bearing torque is greater by a factor of 1.1 than the first bearing torque.

13. The impact wrench according to claim 10, wherein the second bearing torque is greater by a factor of 2 than the first bearing torque.

14. The impact wrench according to claim 10, wherein the second bearing torque is greater by a factor of 5 than the first bearing torque.

15. The impact wrench according to claim 10, wherein the second bearing torque is greater by at least 50 mNm.

16. The impact wrench according to claim 10, wherein the first bearing torque is provided by at least one bearing, wherein the at least one bearing is a rolling-element bearing, and wherein the rolling-element bearing is arranged between the output shaft and the housing.

17. The impact wrench according to claim 10, wherein the second bearing torque is provided by at least one friction bearing, at least one O-ring, or at least one preloadable rolling-element bearing, by a bushing connection between the input shaft and the output shaft, and/or by at least one slip clutch.

18. The impact wrench according to claim 17, wherein the at least one rolling-element bearing comprises a needle roller bearing or a ball bearing.

19. The impact wrench according to claim 10, wherein the first and/or second bearing torque is provided by a plurality of bearing elements.

20. A method for loosening or fastening a screw joint by a tangential impact wrench, the method comprising:
performing impact cycles, wherein, within an impact cycle, a rotor of a hammer mechanism is alternatingly in engagement with an anvil in a first time interval and not in engagement with the anvil in a second time interval; and
providing a torque to the screw joint during the second time interval, the torque being in a range of 10 mNm to 500 mNm.

21. A method for operating a tangential impact wrench, the method comprising:
attaching a plug-on tool to an output shaft of a tangential impact wrench;
establishing an engagement of the plug-on tool with a fastener corresponding to the plug-on tool;
performing impact cycles, wherein, within an impact cycle, a rotor of a hammer mechanism is alternatingly in engagement with an anvil in a first time interval and not in engagement with the anvil in a second time interval; and
providing a damper for reducing a play against a rotational direction of the output shaft between the fastener, the plug-on tool and the output shaft.
